(19) United States
(12) Patent Application Publication
(10) Pub. No.: US 2026/0101077 A1
(43) Pub. Date: Apr. 9, 2026

(54) DEVICES, SYSTEMS, AND METHODS FOR CUSTOMIZING A USER EXPERIENCE DURING A LIVE EVENT

(71) Applicant: Paul M. Herring, Mt. Pleasant, CA (US)

(72) Inventors: Paul M. Herring, Mt. Pleasant, SC (US); Josef Kirk Myers, II, Venice, CA (US); Nicholas David Rawn, Los Angeles, CA (US); William Paul Herring, Mt. Pleasant, SC (US)

(21) Appl. No.: 18/910,635

(22) Filed: Oct. 9, 2024

(51) Int. Cl. H04N 21/266; H04N 21/2187

(52) U.S. Cl. CPC H04N 21/266; H04N 21/2187

(57) ABSTRACT

A computer-implemented method of customizing a user experience during a live event is disclosed herein. The method can include receiving geographic data associated with a location of a customer device, correlating the geographic data associated with the location of the customer device to geographic data associated with a location of a live event, authorizing the customer device to access a plurality of media associated with the live event and hosted by a media server based on the correlation, receiving a media request from the customer device, wherein the media request includes media selected from the plurality of media, evaluating the media request, and adding the media request to a queue of media based on the evaluation, wherein the queue of media is configured to be accessed from the media server and played by a performer device during the live event.

### SUMMARY

In one general aspect, the present disclosure contemplates a method of customizing a user experience during a live event. The method can include receiving, via a host app server, geographic data associated with a location of a customer device, correlating, via the host app server, the geographic data associated with the location of the customer device to geographic data associated with a location of a live event, authorizing, via the host app server, the customer device to access a plurality of media associated with the live event and hosted by a media server based on the correlation, receiving, via the host app server, a media request from the customer device, wherein the media request includes media selected from the plurality of media, evaluating, via the host app server, the media request, adding, via the host app server, the media request to a queue of media based on the evaluation, wherein the queue of media is configured to be accessed from the media server and played by a performer device during the live event.

In another general aspect, the present disclosure contemplates a system configured to customize a user experience during a live event, the system including a customer device including a first processor and a first memory configured to store a media request application that, when executed by the first processor, causes the customer device to retrieve geographic data associated with a location of the customer device, and generate a media request based on a user input, and a host app server including a second processor and a second memory configured to store a media request application that, when executed by the second processor, causes the host app server to receive the geographic data associated with the location of the customer device, correlate the geographic data associated with the location of the customer device to geographic data associated with a location of a live event, receive the media request from the customer device, wherein the media request includes media selected from a plurality of media hosted on a media server, evaluate the media request, and add the media request to a queue of media based on the evaluation, wherein the queue of media is configured to be accessed from the media server and played by a performer device during the live event..

In another general aspect, the present disclosure contemplates a host app server configured to customize a user experience during a live event, the host app server including a processor, and a memory configured to store a media request application that, when executed by the processor, causes the host app server to receive geographic data associated with a location of a customer device, correlate the geographic data associated with the location of the customer device to geographic data associated with a location of a live event, receive a media request from the customer device, wherein the media request includes media selected from a plurality of media hosted on a media server, evaluate the media request, and add the media request to a queue of media based on the evaluation, wherein the queue of media is configured to be accessed from the media server and played by a performer device during the live event.

### BRIEF DESCRIPTION OF THE DRAWINGS

Various embodiments are described herein by way of example in connection with the following figures, wherein:

FIG. 1 illustrates a system diagram of a system configured to autonomously customize a user experience during a live event, according to at least one non-limiting aspect of the present disclosure;

FIG. 2 illustrates an algorithmic flow diagram of a method of initiating a live event via the system of FIG. 1, according to at least one non-limiting aspect of the present disclosure;

FIG. 3 illustrates an algorithmic flow diagram of a method of autonomously customizing a user experience during a live event via the system of FIG. 1, according to at least one non-limiting aspect of the present disclosure;

FIG. 4 illustrates an algorithmic flow diagram of another method of autonomously customizing a user experience during a live event via the system of FIG. 1, according to at least one non-limiting aspect of the present disclosure;

FIGS. 5A-5K illustrate several user interfaces of a media request application configured for use via the system 100 of FIG. 1, according to at least some non-limiting aspects of the present disclosure;

FIGS. 6A-6F illustrate several other user interfaces of a media request application configured for use via the system 100 of FIG. 1, according to at least some non-limiting aspects of the present disclosure; and

FIG. 7 illustrates a diagrammatic representation of a computing device including a host machine within which a set of instructions to perform any one or more of the methodologies discussed herein may be executed, according to at least one non-limiting aspect of the present disclosure

### DETAILED DESCRIPTION

The present invention is directed, in various embodiments, to computer systems and computer-implemented methods that enable a person to customize a user experience during a live event. Accordingly, these systems and methods can be applied to many different forms of live events or entertainment, including but not limited to musical performances, such as concerts and DJ performances, sporting events, any form of theatrical show, improvisational events, comedy shows, variety shows, live streams (e.g., video game demonstrations), e-sports (e.g., video game tournaments), trivia events, lectures, conferences, presentations, and/or exercise demonstrations or classes, amongst other live performances. According to some non-limiting aspects, this can include media presented in a venue (e.g., games, shows, or movies played in a bar). It shall be appreciated that any live event during which media can be streamed from a media server can benefit from the devices, systems, and methods disclosed herein as they can enable the customization of a user experience on behalf of a user, oftentimes autonomously and without active user participation.

As used herein, the expression “term” can include, in a broad sense, one aspect of an agreement between a user of the devices, systems, and methods disclosed herein and a live performer or automated system configured to play media at a live event. The user may have to agree to one or more “terms” that govern the use of the devices, systems, and methods disclosed herein to influence the live event. For example, a user may have to agree to a term specifying that they will be charged for the submission of a media request, regardless of whether or not the live performer fulfills that request during the live event.

As used herein, the expression “condition” can include a specific “term” that grants either the user of the devices, systems, and methods disclosed herein or the live performer at the live event a unilateral right or obligation under the agreement. A user may have to agree to a condition specifying that a request to the live performer will not be submitted until certain prerequisite qualifications of the terms are confirmed. For example, a financial institution server and/or host application server confirms that the user has a required balance in an account maintained with the financial institution. Alternately, a user may have to agree to a condition specifying that the live performer will only be obligated to fulfill that request during the live performance if the user outbids other users of the devices, systems, and methods disclosed herein. In other words, a particular “term” can be contingent on a particular “condition” of the agreement.

It shall be further appreciated that the expression “terms and conditions” is colloquially used to include all of the rules governing a contractual relationship between a provider of a product or service and a user of that product or service, regardless of whether the agreement is governed by a single “term” or a single “condition.” Therefore, as used herein, collective use of the expression “terms and conditions” can refer to all of the provisions governing an agreement between a user of the devices, systems, and methods disclosed herein and a live performer at a live event, regardless of whether that agreement is governed by a single “term” or a single “condition.” The combined advent of mobile devices, WiFi®, high-speed cellular networks, and cloud computing has enabled the average consumer to access a seemingly endless supply of media from their pockets, on a whim. Despite this increased access to on-demand entertainment, live events such as musical performances, sporting events, and shows remain popular pastimes. Even smaller venues may hire a disc jockey (hereinafter “DJ”), a cover band, and/or a comedian to attract more customers. However, “users,” or attendees at such events, are typically passive consumers of live entertainment and are limited in the ways they can interact with a performer and/or influence a performance at such live events. This is especially true when compared to the on-demand nature of their entertainment consumption at home.

To the extent that known devices, systems, and methods for enabling the active consumption of live entertainment are available, manual intervention is typically required. There is no guarantee that a user will take the requisite steps to participate and therefore, most user experiences are not customized. Additionally, there exist technological challenges that prevent a fully autonomous system from dynamically customizing a user experience (e.g., controlling music) during a live event in a social setting, like a bar. For example, known devices, systems, and methods for enabling the active influence of live entertainment generally lack the use of location data and, therefore, prevent the technological optimization of a user experience. Accordingly, for example, conventional technologies lack the ability to discern what music a user prefers to listen to at home relative to in a restaurant, bar, or club. For that matter, conventional technologies are incapable of continuously monitoring and analysing the mood, energy level, and preferences of a crowd. While sentiment analysis technologies (e.g., facial recognition, body language analysis, and sound level monitoring) may exist, interpreting crowd behavior accurately in real time is complex. User reactions to music can be subjective, and conventional technologies are incapable of detecting how a group of users is responding to a specific song because they lack and struggle with deep contextual understanding.

Additionally, conventional technologies and algorithms suffer from limited personalization techniques. While music recommendation systems like Spotify's algorithm may be good at personalizing playlists for individuals, group recommendation is much harder. The technology would need to integrate personal preferences from a large number of people in a way that feels coherent rather than random or generic, something that is still in development. For example, venues such as bars often host diverse crowds with varying musical tastes. Current algorithms, such as those used by music streaming services, can tailor playlists based on individual preferences but struggle to aggregate and satisfy the preferences of a large group in a dynamic environment. Balancing preferences across a group can be complicated and can require real-time decision-making, which current algorithms are not fully capable of. Certain venues, such as bars, may also have changing environments—busy nights, quieter nights, themed events, and more. Conventional devices, systems, and methods are incapable of adapting to these varying contexts.

Likewise, conventional devices, systems, and methods and algorithms lack continuous feedback mechanisms by which they can ascertain whether a performance is effective relative to user preferences. For instance, conventional devices, systems, and methods lack an ability to monitor a user's activity during a live performance, whether a user is enjoying a live performance, and/or when a user leaves a live performance and/or venue. Implementing such a real-time feedback loop would possible only if such devices, systems, and methods could account for other parameters that could influence user behavior, such as the ambiance, food/drink availability, and/or company. Additionally, conventional systems that use facial recognition and/or monitoring devices to gauge crowd reactions, implicant certain privacy issues that could be difficult for a venue to account for. Such restrictions impose technological limitations on the use of certain sensors to track sentiment or preferences that implicate sensitive data.

Although it may be possible to implement certain aspects of the functionality employed by the devices, systems, and methods disclosed herein in the human mind, it shall be appreciated that the sheer scale of users, data, and applications supported by the devices, systems, and methods disclosed herein would render it highly impractical, if not impossible, to do so. In summary, while some parts of the necessary technologies may exist, data aggregation, recommendation engines, and sentiment analysis are not presently integrated into a dependable, adaptive, and real-time system specifically configured to autonomously and predictively influence a live performer during a live event. The complexity of real-time group dynamics, privacy concerns, and the intricacies of human behavior remain significant hurdles. Accordingly, there is a need for devices, systems, and methods for autonomously customizing a user experience during a live event.

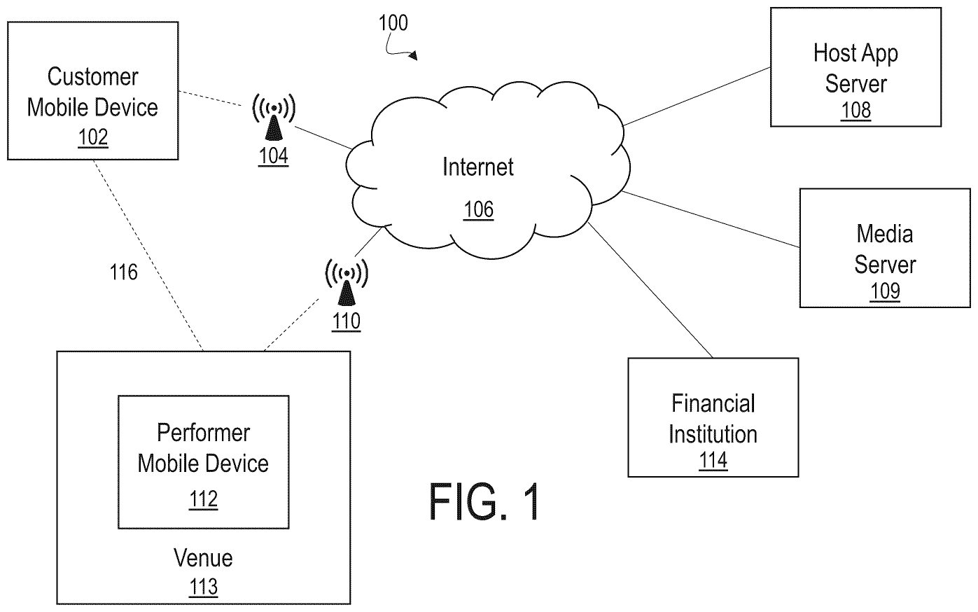

Referring now to FIG. 1, a block diagram of a system 100 configured to autonomously customize a user experience during a live event is depicted in accordance with at least one non-limiting aspect of the present disclosure. According to the non-limiting aspect of FIG. 1, the system 100 can include a customer mobile device 102, a performer mobile device 112 in a venue 113, one or more access points 104, 110 configured to connect the mobile devices 102, 112 to the internet 106, a host server 108, a music server 109, and a financial institution server 114. The customer mobile device 102 of FIG. 1 can be configured to connect to the internet 106 via an access point 104. The performer mobile device 112 can be configured to interact with either a human or automated performer. Non-limiting examples of the mobile devices 102, 112 can include a cell phone, a smart phone, a tablet, a wearable, a laptop, a personal digital assistant, or any other consumer electronic device configured to connect to the internet 106. In some non-limiting embodiments, the mobile devices 102, 112 may not be mobile in a conventional sense and thus, can include a personal desktop computer.

According to some non-limiting aspects of the present disclosure, the access point 104 of FIG. 1 can be configured to connect the customer mobile device 102 to the internet 106 via a wireless network such as WiFi®. In other non-limiting aspects, the access point 104 can be configured to connect the customer mobile device 102 to the internet 106 via a cellular network. In such aspects, the access point 104 can include a cellular tower. According to other aspects, the access point 104 can include a satellite. Therefore, the present disclosure contemplates aspects in which the access point 104 uses any conventional means of connecting the customer mobile device 102 to the internet 106. Because the customer mobile device 102 is connected to the Internet 106 the customer can use the system 100 to interact with a performer and/or influence a live event from any location. However, the present disclosure specifically contemplates non-limiting aspects wherein the customer mobile device 102 generates device-specific data, including location data, configured for use by the system 100 of FIG. 1 to influence a specific performer mobile device 112 in a specific venue 113.

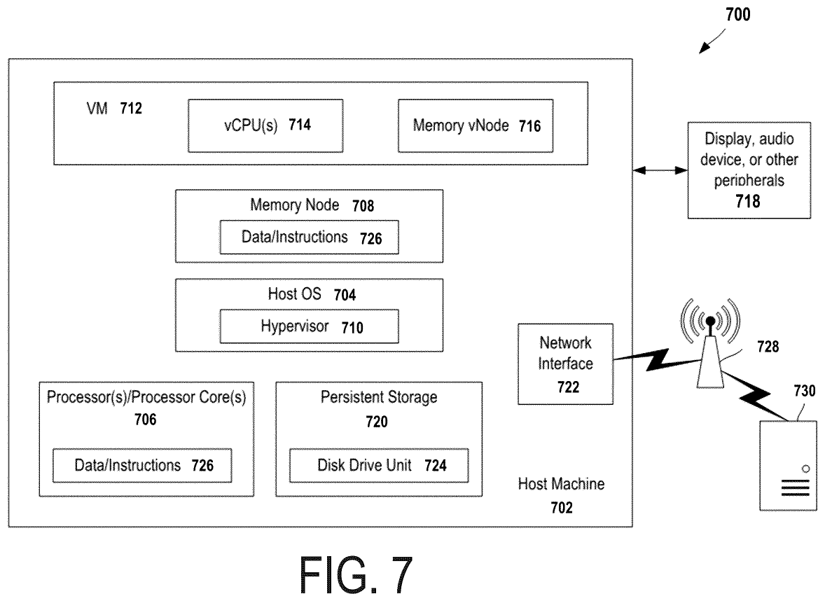

For example, according to the non-limiting aspect of FIG. 1, the customer mobile device 102 can include one or more systems, components, and/or techniques to generate location data, including a global positioning system (“GPS”) receiver, WiFi positioning technology, cell tower triangulation techniques, Bluetooth® beacons, IP addresses and/or sensor fusion, amongst others. As will be described in further detail with reference to FIG. 7, any components of the system 100—including the customer mobile device 102, the performer mobile device 112, and the host app server 108—can include one or more control circuits and/or memories configured to store a media request application that, when executed by the control circuit, causes the customer mobile device 102 to perform the functionality and methods described herein. The media request application can be specifically configured to cause the customer mobile device 102 to transmit requests as well as location information associated with a current geographic position of the customer mobile device 102 to the host server 108, the media server 109, the financial institution 114, and the performer mobile device 112 via the Internet 106. Likewise, the Host App Server 108, the media server 109, the financial institution 114, and the performer mobile device 112 can be configured to communicate with other components of the system 100 via the Internet. It shall be appreciated that, as used herein, the “media request application” associated with the host app server 108, shall be separate and removed from a “media server application” associated with the media server 109. Such separation enables the media request application and host app server 108 to provide users with functionality beyond what the media server application and media server 109 are otherwise capable of providing. It shall be further appreciated that, according to some non-limiting aspects, functionality ascribed to the host app server 108 herein can be incorporated into the customer mobile device 102 and vice versa.

In further reference to FIG. 1, the host app server 108 can be configured to store data and content needed by the media request application, including login credentials, personal information, financial information, preferences, request history, location history, and other content associated with the media request application, as used by the customer mobile device 102. According to some non-limiting aspects, the host app server 108 can be configured to store an algorithmic model that, when executed by the control circuit, can cause the host app server 108 to perform at least a subset of the functionality and/or methods disclosed herein. As will be described in further detail herein, according to other non-limiting aspects, the algorithmic model can include an artificial intelligence model configured to autonomously customize a user experience during a live event, without requiring active participation from a user of the customer mobile device 102. It shall be appreciated, therefore, that the host app server 108 can offload processing functionality that would otherwise be required of the customer mobile device 102, the performer mobile device 112, and/or the media server 109, resulting in a more efficient system that requires less overall computational resources required by the system 100. Additionally, the model can cause the host app server 108 to enable real-time communication between other components of the system 100, such as the customer mobile device 102 and the performer mobile device 112 by managing connections and facilitating the efficient transfer of compliant communications in real-time. This can enable the system 100 to assess the sentiment of users more effectively in the venue 113 and more accurately customize the user experience during the live event, as conducted by the performer mobile device 112. The host server app 108 can further function as an intermediary between the customer mobile device 102, the music server 109, and the performer mobile device 112, enabling users via a customer mobile device 102 to interact with and influence content (e.g., playlists) hosted by the music server 109 in association with an account utilized by the performer mobile device 112, without providing the customer mobile device 102 with direct access to the music server 109 and/or the account utilized by the performer mobile device 112. In other words, due to the host app server 108, a user of the customer mobile device 102 need not have an account on the media server 109 in order to utilize the system 100 to autonomously customize a user experience during a live event.

It shall be further appreciated that the host app server 108 can enable users to seamlessly create an account on the system 100 of FIG. 1 via a OAuth 2.0 authentication protocol. For example, assuming a user of the performer mobile device 112 has an account associated with the media server 109, the user of the performer mobile device 112 can easily create a system 100 account via the account associated with the media server 109. The host app server 108 and media server 109 can be communicatively coupled via an application programming interface (API) associated with the media server 109. For example, upon receiving an account initiation request—including credentials associated with the media server 109 account—from the performer mobile device 112, the host app server 108 can be configured to utilize the provided credentials to access the media server 109 and generate a system 100 account based on data stored on the media server 109 in association with the media server 109 account. According to some non-limiting aspects, the media server 109 can initiate a two-factor authentication protocol via the performer mobile device 112, independent of the host app server 108, to ensure that the request of the host app server 108 was actually authorized by the performer mobile device 112. As such, it shall be appreciated that the host server 108 can enable more efficiency on behalf of system 100 users while enhancing the security of the overall system 100.

Still referring to the non-limiting aspect of FIG. 1, the media server 109 can be configured to host a media service on behalf of the performer mobile device 112. For example, the performer mobile device 112 can access and play media (e.g., music, videos, lectures, audio books, live streams, etc.) stored on the media server 109 during a live performance hosted at the venue 113 by accessing the media server 109 via the Internet 106 using a media server 109 account. The media server 109 can store the requested media, process the transmission of media data from a source, and/or otherwise access the requested media. For example, the media server 109 can be configured to host a plurality of digital media files, sometimes in a cloud-based infrastructure. The files, for example, can be encoded using an efficient compression format, such as Ogg Vorbis or ACC to reduce the file size without a noticeable loss in media quality. In response to a media request transmitted via a user input provided by a media server 109 application stored and executed by the performer mobile device 112, the media server 109 can identify a hosted media file associated with the request and begin buffering a portion of the file such that playback can be immediately initiated via the performer mobile device 112 while the rest of the file downloads. The media server 109 can be further configured to adjust the media quality via several techniques, including adaptive bitrate streaming, which dynamically changes the quality based on a speed of connection by which the performer mobile device 112 is accessing the Internet 106. For example, if the connection weakens, the media server 109 can adjust the quality to preserve continuous playback of the media via the performer mobile device 112 without interruption.

According to some non-limiting aspects, the media server 109 of the system 100 of FIG. 1 can implement a peer-to-peer protocol by which a load is reduced on the overall system 109. According to such protocols, the media server 109 distributes portions of media files across a plurality of devices, including the customer mobile device 102, host app server 108, and performer mobile device 112, for example, such that the ultimate functionality is achieved without overloading or overclocking any one component of the system 100. According to some non-limiting aspects, the media server 109 can include one or more edge servers for real-time data processing, which can benefit in monitoring user interactions, managing metadata, and customizing content on behalf of the customer mobile device 102 and performer mobile device 112 via intermediary interactions provided by the host app server 108. According to still other non-limiting aspects, the media server 109 can be specifically configured to ingest the media via specific protocols (e.g., real-time messaging protocols, secure reliable transport, WebRTC, etc.), encode the media into a digital format compatible with the performer mobile device 112 (e.g., H264, H265, etc.), and/or transcode the video into different formats and/or resolutions, thereby optimizing a user experience regardless of Internet speed. According to some non-limiting aspects, the media server 109 can include a content delivery network, or a network of geographically distributed servers that store and deliver media content to the performer mobile device 112 and/or customer mobile device 102 based on geographic data associated with the performer mobile device 112 and/or customer mobile device 102. It shall be appreciated, however, that by utilizing one or more edge servers of the media server 109 can further improve scalability, supporting far more customer mobile devices 102 and performer mobile devices 112 than conventional technologies, optimize bandwidth utilization of the overall system 100 and reduce latency provided via conventional content delivery networks.

According to the non-limiting aspect of FIG. 1, the media server 109 can be configured to manage digital rights one behalf of the system 100. For example, in the same way that the host app server 108 enables users of customer mobile devices 102 to interact with a media server 109 account associated with he performer mobile device 112 without having a media server 109 account of their own, it shall be appreciated that—by interfacing and interacting with the media server 109—neither the customer mobile device 102 nor the host app server 108 need worry about the management or infringement of digital rights associated with media hosted by the media server 109. Conventional technologies require that a customer mobile device 102 or host app server 108 maintain their own media server 109 accounts and obtain their own licenses, (e.g., by downloading and hosting their own version of the media server 109 application, which gates access to the media server 109 via individual media server 109 accounts for the customer mobile device 102 and host app server 108). However, according to the non-limiting aspect of FIG. 1, the media server 109 can maintain all licenses and prevent unauthorized copying or redistribution of the media it hosts on behalf of the overall system 100. Therefore, it shall be appreciated that the system 100 enables a customized user experience on behalf of the customer mobile device 102, which transmits media requests and preferences to the host app server 108, and the host app server 108, which manages media requests sent by the customer mobile device 102. Accordingly, it shall be appreciated that the system 100 of FIG. 1 enables the participation in a customized user experience beyond the functionality of conventional technologies.

It shall be further appreciated that, according to some non-limiting aspects, media requests generated by the customer mobile device 102 of the system 100 of FIG. 1 can include supplemental data (e.g., geographic data, sensor data) generated the customer mobile device 102, which can influence how the host app server 108 processes the media request, thereby further enhancing autonomous customization of the user experience during the live event. For example, media requests generated by the customer mobile device 102 can include geographic data generated by the customer mobile device 102. Aside from using the geographic data to process a specific media request (e.g., confirm the user of the customer mobile device 102 is within or in proximity of the venue 113), the host app server 108 can be configured to track geographic data associated with media requests transmitted by customer mobile devices 102. Accordingly, the system 100 can be specifically configured to generate specific insights as to what media is requested in a particular location of a plurality of locations. Such insights, for example, can include specific media that users request in particular venues, such as a residence, as compared to a bar, restaurant, a gym, a school, a club, etc.

According to some non-limiting aspects, media requests provided by the customer mobile device 102 of the system 100 of FIG. 1 can include activity data generated by one or more sensors (e.g., accelerometers, cameras, gyroscopes, microphones, etc.) or applications (e.g., health applications) associated with the customer mobile device 102. Similarly, the system 100 can be specifically configured to generate specific insights as to what media is requested when a user of the customer mobile device 102 is participating in particular activities (e.g., sitting, walking, working, running, working out, etc.). Such insights, for example, can be implemented to determine where and how a performer associated with the performer mobile device 112 or another performer performs in future live events (e.g., venue selection, media selection, etc.).

According to other non-limiting aspects, media requests can include sensor data generated by one or more sensors (e.g., accelerometers, cameras, gyroscopes, microphones, etc.) associated with the customer mobile device 102, wherein the sensor data can be used to assess and ascertain an environment of the venue 113. For example, the sensor data can include audio data generated by a microphone of the customer mobile device 102 or image data generated by a camera of the customer mobile device 102, which the host app server 108 can use to assess a number of attendees at the venue 113 and/or a noise level associated with the venue 113, thereby enabling the system 100 to assess the environment (e.g., vibe, feel, mood, etc.) and factor the assessment into the processing of media requests to customize the user experience on behalf of the customer mobile device 102. Although media requests may be limited to media specified on a plurality of acceptable media as defined by a performer associated with the performer mobile device 112, the host app server 108 may determine that fulfilling a particular media request may not be appropriate based on the assessed environment. For example, even if a heavy metal song is included on a playlist of available songs to be played by the performer, the host app server 108 may determine that playing the heavy metal song is inappropriate if the sensor data indicates that the environment is low key (e.g., low number of attendees, low volume, etc.). It shall be appreciated that the sensor data, geographic data, and/or applications can be accessed by the media request application via a setting of the customer mobile device 102 and/or APIs that interface with ancillary applications associated with the customer mobile device 102.

According to some non-limiting aspects, the system 100 can be configured to use geographic data associated with the customer mobile device 102 to passively customize a user experience during a live event hosted at the venue 113. In other words, the user does not have to actively initiate and transmit a media request to the host server 108 via a provision of a real-time user input. Rather, upon initially logging into the media request application and setting up a media request application account via the customer mobile device 102, the user can establish user settings and/or preferences (e.g., preferred songs, artists, genres, etc.). Such settings and/or preferences can be transmitted to and stored on the host app server 108. After initialization, manual intervention of the user need not be required. For example, the media request application can cause the customer mobile device 102 to continually transmit geographic data to the host app server 108. Upon receipt, the host app server 108 can correlate geographic information received from the customer mobile device 102 to geographic information associated with the venue 113 to host a live event or session, as initiated by a performer via the performer mobile device 112. Assuming the host app server 108 can successfully correlate the geographic information received from the customer mobile device 102 to geographic information associated with the venue 113, the host app server 108 may apply the stored settings and/or preferences associated with the media request application account to generate a media request on behalf of a user of the customer mobile device 102 or otherwise influence the processing of other media requests, including those actively generated by other users associated with other customer mobile devices 102.

For example, when a user of the customer mobile device 102 enters a venue 113, the media request application can transmit geographic data associated with the customer mobile device 102 and the host app server 102 can correlate the geographic data associated with the customer mobile device 102 to an event established by the performer to take place in the venue 113 at that particular time. The host app server 108 can subsequently and autonomously access the settings and/or preferences associated with the user of the customer mobile device 102 and asses, for example, if a particular song included in the settings and/or preferences is included on a playlist of available songs established by the performer and to be played by the performer in the venue 113 during the live event. If, for example, the song included in the settings and/or preferences is in fact included on a playlist of available songs established by the performer, the host app server 108 can generate and process a media request for that song to be played autonomously, without manual intervention of the user of the customer mobile device 102. However, if the song included in the settings and/or preferences is not included on the playlist of available songs established by the performer, the host app server 108 may generate and process a media request for a comparable song on the playlist, including songs by the same artist or of similar genres. Accordingly, the host app server 108 can generate and process a media request for the comparable song to be played autonomously, without manual intervention of the user of the customer mobile device 102. It shall be appreciated, therefore, that the system 100 can ensure that, every time a user associated with a customer mobile device enters a venue 113 (e.g., a stadium, an auditorium, a bar, a restaurant, a club, etc.) hosting a live event, that user is autonomously influencing the performance, ensuring their input as to what media is being played is accounted for in the performance.

In further reference to FIG. 1, the financial institution server 114 can be configured to host a financial account associated with a user of the customer mobile device 102. For example, the financial institution server 114 can include a bank that maintains and manages a bank account the customer has linked to their user profile, which is stored in the host server 108. Additionally, and/or alternatively, the financial institution 114 can be a third-party service, such as PayPal®, Square ®, or the like. According to some non-limiting aspects, the financial institution server can include a credit card server, a cryptocurrency exchange, and/or a blockchain network configured to host a distributed ledger that manages ownership and transactions of digital assets. Essentially, the financial institution server 114 of FIG. 1 represents any server capable of processing a payment on behalf of the host app server 108. Once the financial institution server 114 processes a payment, the host app server 108—via an API associated with the financial institution server 114—can be configured to receive a confirmation that the payment has been processed to the customer mobile device 102 and/or performer mobile device 112. Likewise, the host app server 108 can transmit a confirmation that the payment has been processed to the customer mobile device 102 via an API associated with the host app server 108. For example, according to some non-limiting aspects, the host app server 108 may implement a term and/or condition associated with a media request. Some terms and/or conditions contemplated by the present disclosure may require or optionally include a payment (e.g., a payment as a condition of the request, a tip for the performer, etc.), a purchase of a good or service provided at, by, or in association with the venue 113 or performer, an auction, and/or a crowdsourcing goal (e.g., a cumulative financial threshold must be exceeded prior to processing the same media request transmitted by a plurality of customer mobile devices 102), amongst other transactions. As such, the host app server 108 can forward the request to the financial institution server 114 for processing prior to managing the media request transmitted by the customer mobile device 102. Once the host app server 108 receives a confirmation from the financial institution server that the payment has been processed and similarly confirms that all additional terms and/or conditions associated with the request have been satisfied, only then will the host app server 108 manage the media request transmitted by the customer mobile device 102.

It shall be further appreciated that, according to some non-limiting aspects, the terms and/or conditions contemplated by the present disclosure do not involve a monetary transaction. For example, according to some non-limiting aspects, the terms and/or conditions can include acceptance of a privacy policy associated with the host app server 108, acceptance of a data policy associated with the host app server 108, participation in a survey, various social media interactions (e.g., “liking” an account or post associated with the venue 113, performer and/or sponsored product, sharing an account or post associated with the venue 113, performer and/or sponsored product, commenting on an account or post associated with the venue 113, performer sponsored product, posting and providing a required hash-tag, etc.), a location the customer mobile device 102—as confirmed via geographic data provided by the customer mobile device 102, reading of a machine-readable code located at or in proximity with the venue 113 (e.g., a UPC, a QR code, an audible code, etc.), a voting scheme, provision of user data (e.g., email address, phone number, name, etc.), redemption of a code or offer via the media request application hosted by the customer mobile device 102, user interaction with a sponsored link provided via the media request application hosted by the customer mobile device 102, and/or the customer mobile device 102 visiting a particular website, amongst others. Similar to the aforementioned interactions between the host app server 108 and the financial institution server 114, the host app server 108 can be configured to monitor the completion of such terms and/or conditions. According to some non-limiting aspects, the host app server 108 can monitor the completion of terms and/or conditions via various APIs, including APIs associated with the host app server 108 and/or various websites, social media services, etc.

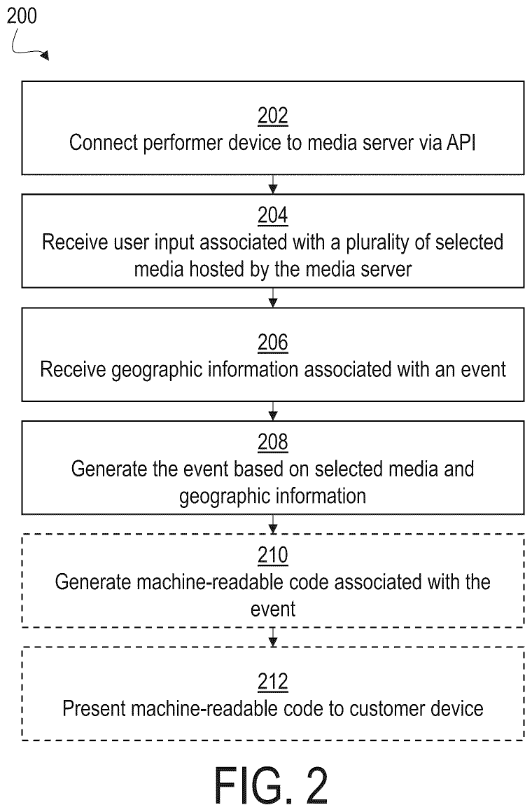

Referring now to FIG. 2, an algorithmic flow diagram of a method 200 of initiating a live event via the system of FIG. 1 is depicted in accordance with at least one non-limiting aspect of the present disclosure. The method 200 of FIG. 2 can be executed by a performer mobile device 112 (FIG. 1) of the system 100 of FIG. 1 in response to the media request application being executed by one or more processors of the performer mobile device 112 (FIG. 1). However, it shall be appreciated that, according to other non-limiting aspects, the method 200 can be performed by any other component of the system 100 of FIG. 1, or by combinations of components thereof.

According to the non-limiting aspect of FIG. 1, the method 200 can include connecting 202 the performer mobile device (112) to the media server 109 (FIG. 1) via an API. As previously described, the connection can include use of an OAuth 2.0 authentication protocol. For example, assuming a user of the performer mobile device 112 (FIG. 1) has an account associated with the media server 109 (FIG. 1), the user of the performer mobile device 112 (FIG. 1) can easily create a system 100 (FIG. 1) account via the account associated with the media server 109 (FIG. 1) and connect the media request application to the media server 109 (FIG. 1) via those credentials. According to some non-limiting aspects, the media server 109 (FIG. 1) can initiate a two-factor authentication protocol via the performer mobile device 112 (FIG. 1), independent of the host app server 108 (FIG. 1), to ensure that the request of the host app server 108 (FIG. 1) was actually authorized by the performer mobile device 112 (FIG. 1).

The method 200 of FIG. 2 can further include receiving 204 a user input associated with a plurality of selected media hosted by the media server. According to some non-limiting aspects, the selected media can include all of the media hosted by the media server 109 (FIG. 1). However, according to other non-limiting aspects, the selected media can include a subset (e.g., playlist) of the media hosted by the media server 109 (FIG. 1), thereby limiting media requests to media included in the subset. For example, the performer may determine that certain media hosted by the media server 109 (FIG. 1) is more appropriate for the venue 113 (FIG. 1) rather than other media hosted by the media server 109 (FIG. 1). According to some non-limiting aspects, the subset can include sponsored media. For example, the performer may agree with an artist to feature one or more media files, which can be included or even highlighted in the subset to attract attention from the attendees. According to some non-limiting aspects, the system 100 (FIG. 1) can be configured to ensure that sponsored media is played. According to still other non-limiting aspects, the system 100 (FIG. 1) can be configured to attribute a certain number of media requests and/or data associated with media requests (e.g., votes, bids, etc.) to sponsored media to maintain the integrity of the system 100 (FIG. 1). The method 200 can further include receiving 206 geographic information associated with the event. For example, the geographic information can be associated with an address of the venue 113 (FIG. 1). As such, the method 200 can further include generating 208 the event based on selected media and geographic information. Upon generation, the event is available in the media request application and can be viewed by the customer mobile device 102 (FIG. 1) and managed by the host app server 108 (FIG. 1). According to some non-limiting aspects, the method 200 can include generating 210 a machine-readable code associated with the generated event and presenting 212 the machine-readable code to be interpreted by the customer mobile device 102 (FIG. 1). For example, the machine-readable code can include a QR code, a UPC, and RFID, and/or an audible signal, and any other code including a unique identifier assigned to the event. Upon interpreting the machine-readable code, the customer mobile device 102, via the media request application, can access the generated event and generate a media request associated with the event.

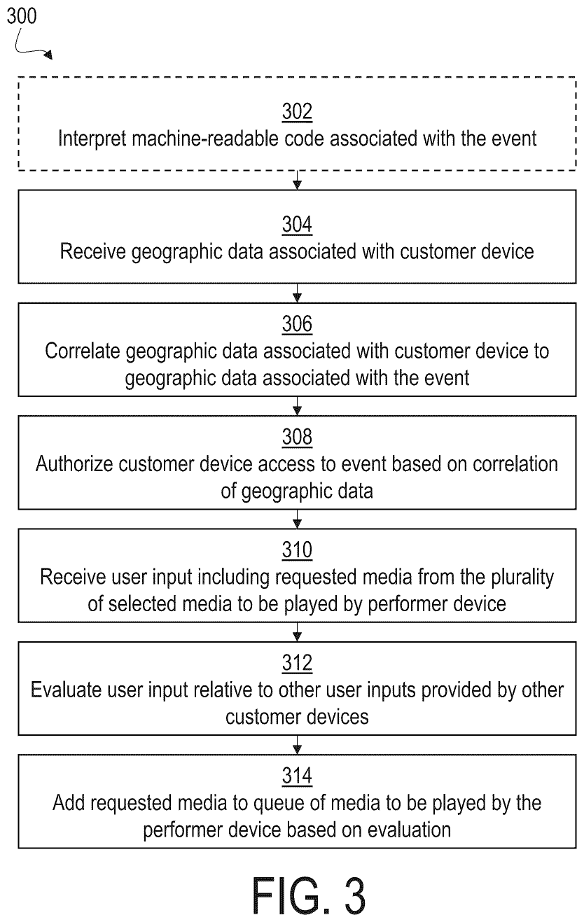

Referring now to FIG. 3, an algorithmic flow diagram of a method 300 of autonomously customizing a user experience during a live event via the system of FIG. 1 is depicted in accordance with at least one non-limiting aspect of the present disclosure. The method 300 of FIG. 3 can be executed by a host app server 108 (FIG. 1) of the system 100 of FIG. 1 in response to the media request application being executed by one or more processors of the host app server 108 (FIG. 1). However, it shall be appreciated that, according to other non-limiting aspects, the method 300 can be performed by any other component of the system 100 of FIG. 1, or by combinations of components thereof.

According to the non-limiting aspect wherein the method 200 of FIG. 2 includes generating 210 (FIG. 2) a machine-readable code associated with the generated event and presenting 212 (FIG. 2) the machine-readable code to be interpreted by the customer mobile device 102 (FIG. 1), the method 300 of FIG. 3 can include interpreting 302 the machine-readable code associated with the event. Regardless, the method 300 can include receiving 304 geographic information associated with the customer mobile device 102 (FIG. 1) accessing the event and correlating 306 geographic data associated with customer mobile device (FIG. 1) to geographic data associated with the event. Assuming the geographic information associated with customer mobile device 102 (FIG. 1) is properly correlated to the geographic information associated with the event, the method 300 can further include authorizing the customer device to access to event via the media request application based on correlation. In other words, the method 300 of FIG. 3 ensures that the user of the customer mobile device (FIG. 1) is actually located at the venue 113 (FIG. 1) prior to allowing the user of the customer mobile device (FIG. 1) to influence the live event. According to the non-limiting aspect wherein no manual intervention is required of the user of the customer mobile device 102 (FIG. 1), the media request application can autonomously and continuously transmit geographic data associated with the customer mobile device 102 (FIG. 1) to the host app server 108 (FIG. 1).

Still referring to FIG. 3, the method 300 can further include receiving 310 a user input including requested media from the plurality of selected media to be played by performer mobile device 112 (FIG. 1). This user input, for example, can be provided via a media request generated and transmitted by the customer mobile device 102 (FIG. 1), which receives the user input. For example, upon successfully accessing the event, the customer mobile device 102 (FIG. 1) can display the plurality of selected media to the user via the media request application. However, according to the non-limiting aspect wherein no manual intervention is required of the user of the customer mobile device 102 (FIG. 1), the host app server 108 (FIG. 1) can retrieve initial user inputs it stored based on user settings and/or preferences and autonomously generate a media request on behalf of the user of the customer mobile device 102 (FIG. 1). Regardless, the method 300 can further include evaluating 312 the user input relative to other user inputs provided via other media requests associated with other customer mobile devices 102 (FIG. 1). In other words, if there is a term and/or condition associated with the media requests, those shall be considered by the host app server 108 (FIG. 1). For example, media requests that do not comply with the terms and/or conditions may be discarded. If the terms and/or conditions require a voting scheme, media requested by the media requests shall be tallied and the most requested media will be added to a queue of media to be played by the performer mobile device 112 (FIG. 1). If the terms and/or conditions require an auction, bids associated with each of the media requests shall be tallied and the media request associated with the highest bid will be added to a queue of media to be played by the performer mobile device 112 (FIG. 1), pending confirmation from the financial institution server 114 (FIG. 1). Of course, other terms and/or conditions can attenuate the evaluation process accordingly, including those previously described. Finally, the method 300 can include adding 314 the requested media to a queue of media to be played by the performer device based on the evaluation.

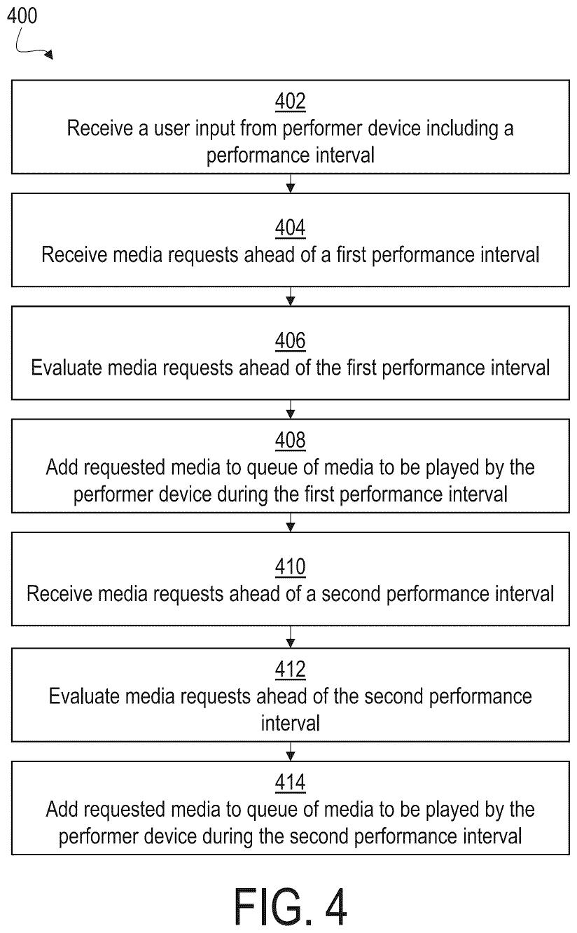

Referring now to FIG. 4, an algorithmic flow diagram of another method 400 of autonomously customizing a user experience during a live event via the system of FIG. 1 is depicted in accordance with at least one non-limiting aspect of the present disclosure. The method 400 of FIG. 4 can be executed by a host app server 108 (FIG. 1) of the system 100 of FIG. 1 in response to the media request application being executed by one or more processors of the host app server 108 (FIG. 1). However, it shall be appreciated that, according to other non-limiting aspects, the method 300 can be performed by any other component of the system 100 of FIG. 1, or by combinations of components thereof.

According to the non-limiting aspect of FIG. 4, the method 400 can include receiving 402 a user input from the performer mobile device 402 (FIG. 4) including a performance interval. For example, the performance interval can include a predetermined amount of time by which the host app server 108 (FIG. 1) evaluates media requests, as specified in reference to the method 300 of FIG. 3. The method 400, therefore, can include receiving 404 media requests ahead of the first performance interval and evaluating 406 the media requests ahead of the first performance interval. Based on the evaluation, the method 400 can further include adding 408 requested media to a queue of media to be played by the performer mobile device 112 (FIG. 1) based on the evaluation. While the media is being played off the queue by the performer mobile device 112 (FIG. 1) during the first interval, the method 400 can further include receiving 410 media requests ahead of a second performance interval, evaluating 412 media requests ahead of the second performance interval, and adding 414 the requested media to queue of media to be played by the performer device during the second performance interval. In this way, the method 400 can ensure a dynamic influence of the performance, accounting for continual active or passive participation from attendees throughout the live event at the venue 113 (FIG. 1).

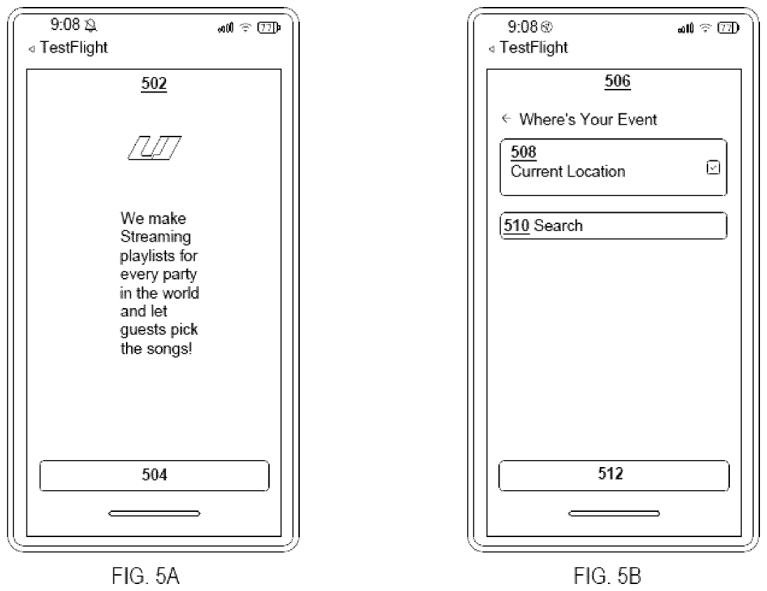

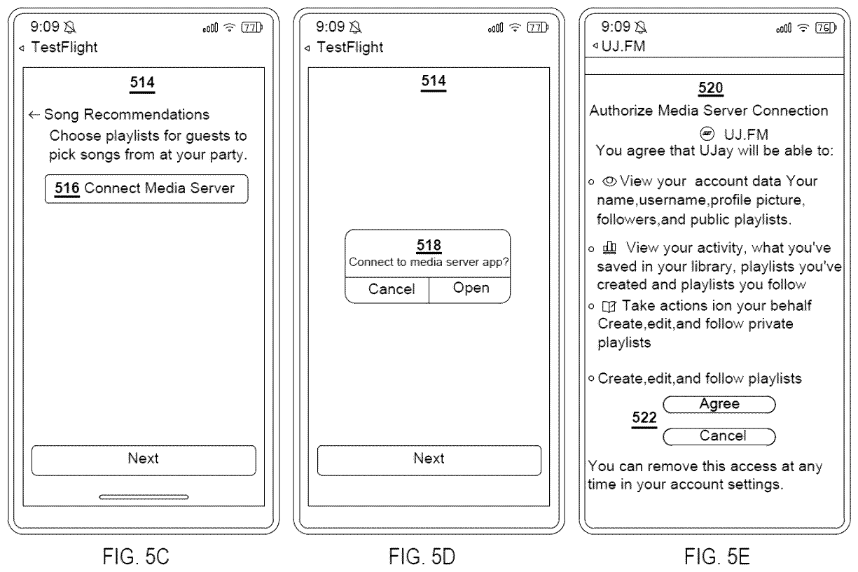

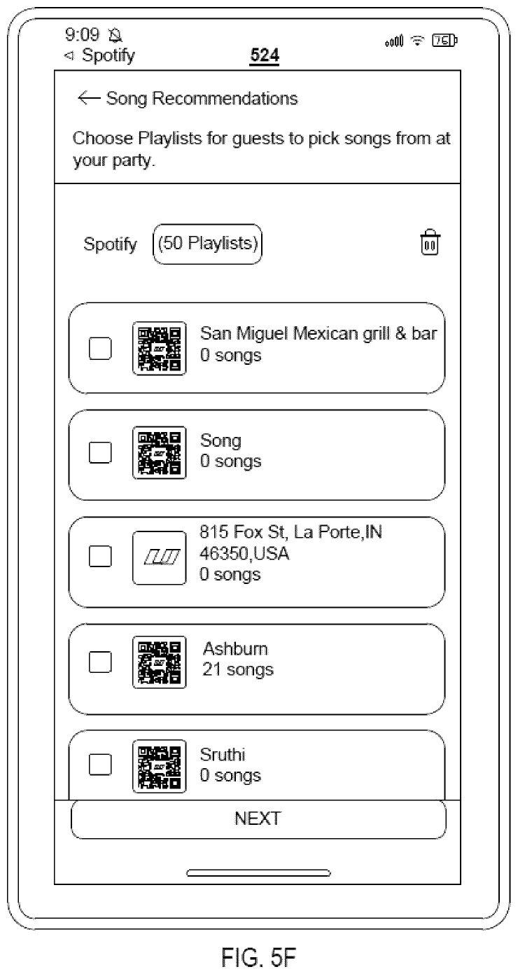

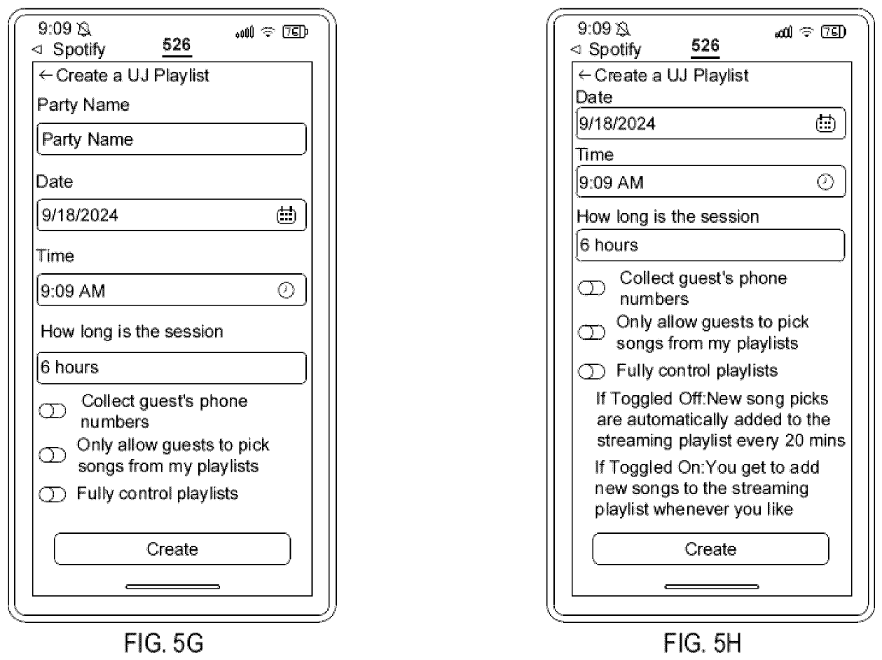

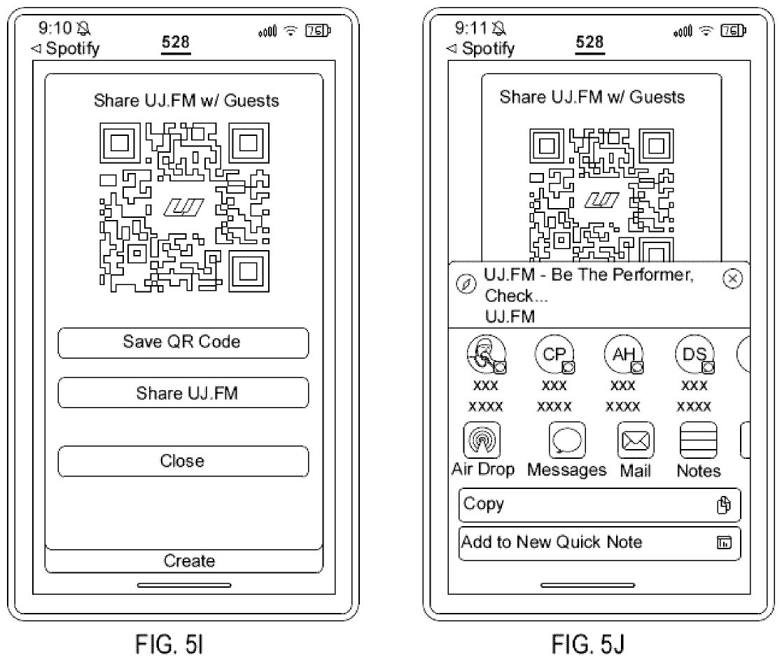

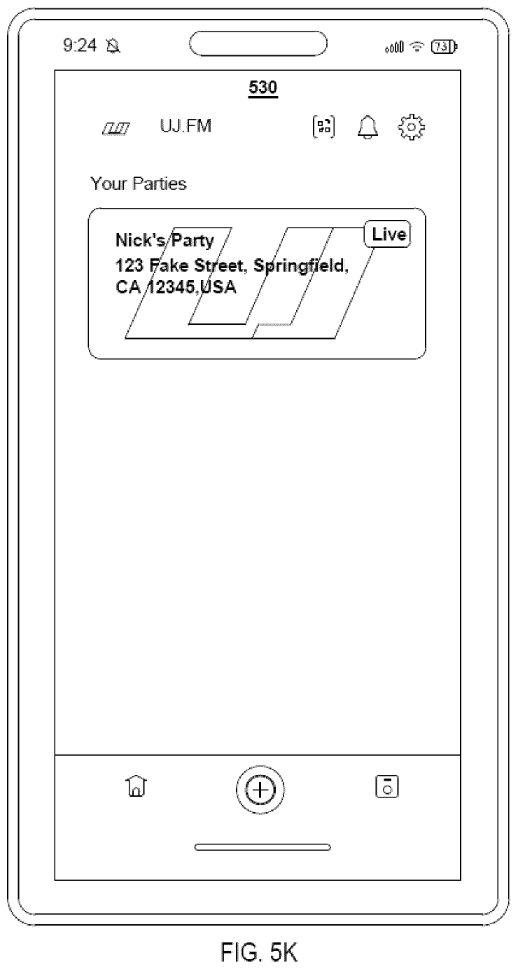

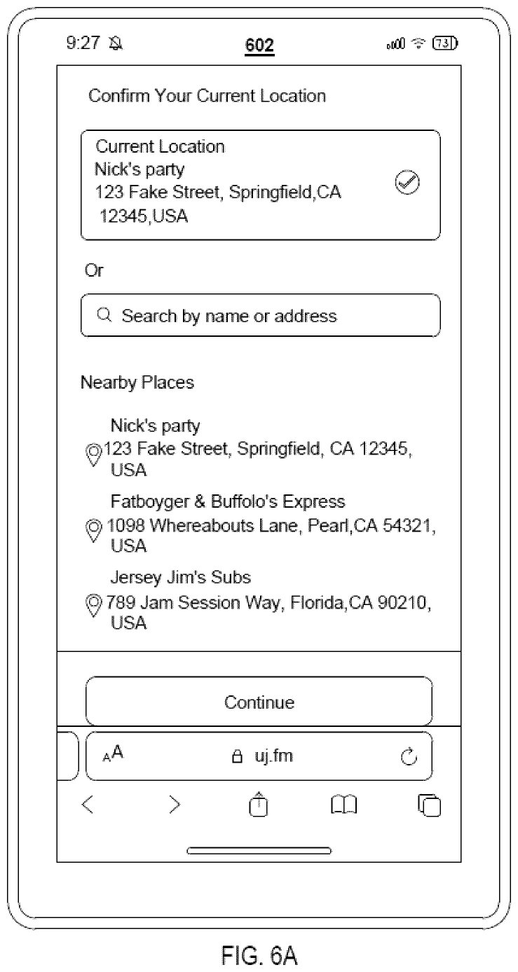

Referring now to FIGS. 5A-5K, several user interfaces of a media request application configured for use via the system 100 of FIG. 1 are depicted in accordance with at least one non-limiting aspect of the present disclosure. For example, the user interfaces of FIGS. 5A-5K can be configured for display via the performer mobile device 112 (FIG. 1). However, it shall be appreciated that, according to other non-limiting aspects, the user interfaces of FIGS. 5A-5K can be configured for display via any other system 100 (FIG. 1) component. According to some non-limiting aspects, at least portions of the user interfaces of FIGS. 5A-5K can be provided or otherwise supported via the host app server 108 (FIG. 1). According to the non-limiting aspect of FIG. 5A, a first user interface 502 can be configured to welcome a user, such as a performer, to the system 100 (FIG. 1), including a widget 504 by which the user can create a session or live event, including a plurality of selected media from the media server 109 (FIG. 1) to be made available to attendees at the session or live event hosted at the venue 113 (FIG. 1). Upon user interaction with the widget 504, the system 100 (FIG. 1) can initiate a second interface 506, as illustrated in FIG. 5B. The second user interface 506, for example, can enable the user to attribute geographic data to the desired event. For example, the second user interface 506 can include a second widget 508, which can enable the user to utilize the aforementioned location identifying hardware and techniques to identify a current location of the performer mobile device 112 (FIG. 1), such that the system 100 (FIG. 1) utilizes the identified current location of the performer mobile device 112 (FIG. 1) as the event location. Additionally, the second user interface 506 can include a third widget 510, which can enable the user to search for a specific address or landmark to be associated with the desired event.

According to the non-limiting aspect of FIG. 5C, a third user interface 514 can include a fourth widget 516 configured to enable the user to connect to the media server 109 (FIG. 1) to select a plurality of media to be made available to attendees at the session or live event hosted at the venue 113 (FIG. 1). Upon interacting with the fourth widget 516, the third user interface 514 a window 518 will present a window 518 requesting the user to confirm a connection to a media server application associated with the media server 109 (FIG. 1), as depicted in FIG. 5D. This will initiate a fourth user interface 520, as depicted in FIG. 5E, which presents terms associated with the connection and a fifth widget 522 by which the user can agree to or cancel the connection based on the terms. Upon connecting to the media server 109 (FIG. 1), a fifth user interface 524 can enable the user to select a plurality of media to be made available to attendees at the session or live event hosted at the venue 113 (FIG. 1). For example, the media can be selected to be customized to the event or venue (e.g., if the event is taking place at a Mexican restaurant, Mexican music may be selected). FIGS. 5G and 5H depict a sixth user interface 526, which can enable the user to enter additional details associated with the live event. This can include a date of the event, a time of the event, a session duration, according to the non-limiting aspect of FIG. 4, and configuration by which attendee information from a customer mobile device 102 (FIG. 1) or control/limit media played during the live event. Such settings can control whether new media requests are automatically added to a playlist during the duration (e.g., every 20 minutes) or if the performer gets to control what media requests are or are not fulfilled. According to some non-limiting aspects, this information can include particular parameters and/or rules associated with a term and/or condition to be associated with the media request, as previously described.

FIGS. 5I and 5J depict a seventh user interface 528 by which a user can cause the performer mobile device 112 (FIG. 1) and/or host app server 108 (FIG. 1) to generate a unique, machine-readable code associated with the live event generated in reference to FIGS. 5A-5G. As previously described, upon reading the machine-readable code, a customer mobile device 102 (FIG. 1) can connect to the live event and generate media requests to be played via the performer mobile device 112 (FIG. 1) during the live event. The user interface 528 can enable a user to share the machine-readable code with attendees, as depicted in FIG. 5J. Of course, alternately, a user can search for and otherwise identify generated events, via geographic data and/or searching for the venue 113 (FIG. 1) or other identifying information, as provided via the sixth user interface 526 of FIGS. 5G and 5H. Upon successful generation of the live event, an eighth user interface 530 can display the generate event and any other events generated by the live performer, as depicted in FIG. 5K.

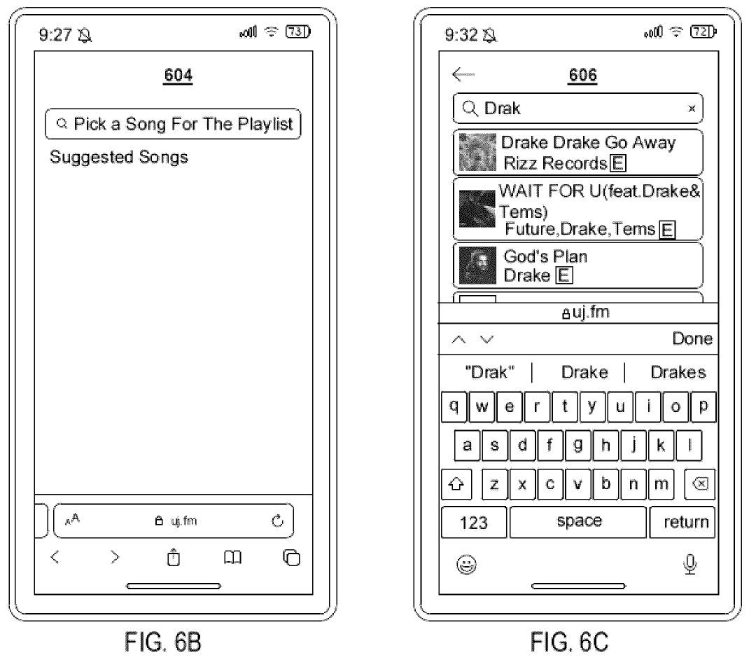

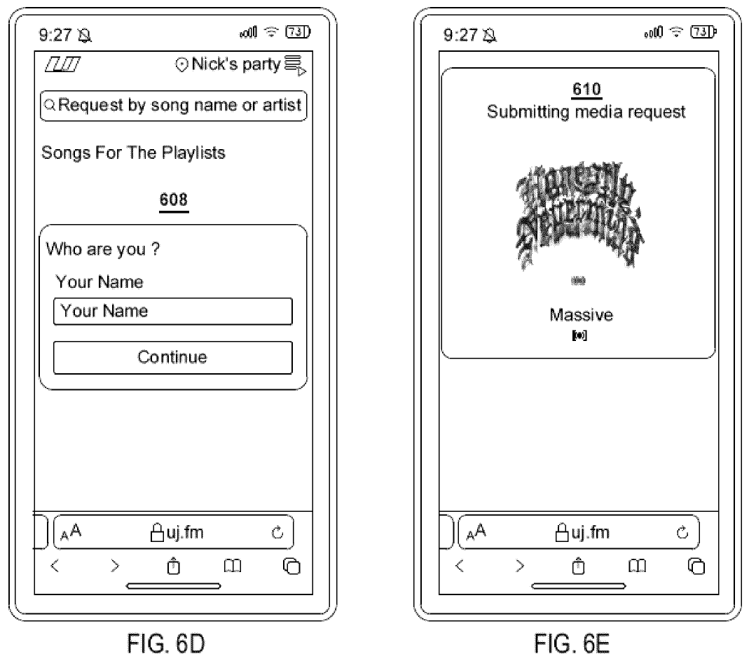

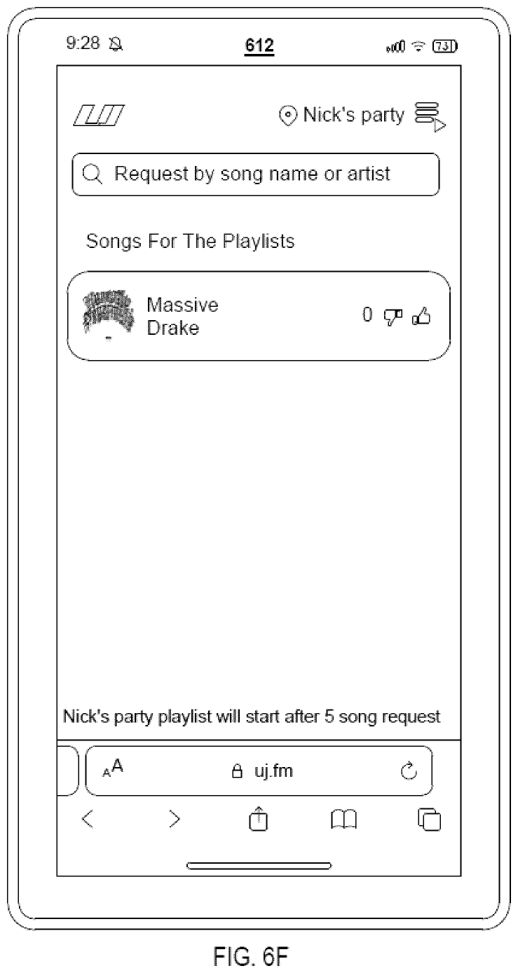

Referring now to FIGS. 6A-6F, several other user interfaces of a media request application configured for use via the system 100 of FIG. 1 are depicted in accordance with at least some non-limiting aspects of the present disclosure. For example, the user interfaces of FIGS. 6A-6F can be configured for display via the customer mobile device 102 (FIG. 1). However, it shall be appreciated that, according to other non-limiting aspects, the user interfaces of FIGS. 6A-6F can be configured for display via any other system 100 (FIG. 1) component. According to some non-limiting aspects, at least portions of the user interfaces of FIGS. 6A-6F can be provided or otherwise supported via the host app server 108 (FIG. 1). According to the non-limiting aspect of FIG. 6A, a ninth user interface 602 can prompt a user to provide a location of a live event they would like to influence. As previously described, this can be automatically assessed via the media request application based on the location identifying hardware and techniques previously described. Alternately, the ninth user interface 602 can provide the user with a list of nearby events or enable a user to search for a specific event.

According to some non-limiting aspects, the media request application can autonomously and continually send the host app server 108 (FIG. 1) geographic data generated by the customer mobile device 102 (FIG. 1) without require manual or active participation of the user via the ninth user interface 602. As such, the host app server 108 (FIG. 1) always autonomously knows if the user is at an event and can autonomously generate media requests on their behalf.

In reference to FIG. 6B, a tenth user interface 604 can prompt the user to pick media to be included in a media request. This can launch an eleventh user interface 606, as depicted in FIG. 6C, which lists media (e.g., songs) that from the plurality of selected media programmed by the performer for the live event, as previously described. The eleventh user interface 606 enables a user to either view and select media or search for specific media. A twelfth user interface 608, as depicted in FIG. 6D, can prompt a user to provide additional information associated with the media request, including any actions or information necessary to fulfill the aforementioned terms and/or conditions, which can be associated with the media request. A thirteenth user interface 610 can confirm that the media request has been successfully submitted to the host app server 108 for fulfillment. Finally, FIG. 6F depicts a fourteenth user interface 612 that can enable the user to view their pending media requests and provide a status of the media request. As depicted in FIG. 6F, the fourteenth user interface 612 can provide other information associated with the media request (e.g., how many other attendees have requested the media) and can enable the user to provide feedback associated with the media request.

Referring now to FIG. 7, a diagrammatic representation of a computing device 700 including a a host machine 702 within which a set of instructions to perform any one or more of the methodologies discussed herein may be executed is depicted in accordance with at least one non-limiting aspect of the present disclosure. The computing device 700 can be representative of an component of the system 100 shown in FIG. 1. In various aspects, the host machine 702 operates as a standalone device or may be connected (e.g., networked) to other machines. In a networked deployment, the host machine 702 may operate in the capacity of a server or a client machine in a server-client network environment, or as a peer machine in a peer-to-peer (or distributed) network environment. The host machine 702 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 700 includes the host machine 702, running a host operating system (OS) 704 on a processor or multiple processor(s)/processor core(s) 706 (e.g., a central processing unit (CPU), a graphics processing unit (GPU), or both), and various memory nodes 708. The host OS 704 may include a hypervisor 710 which is able to control the functions and/or communicate with a virtual machine (“VM”) 712 running on machine readable media. The VM 712 also may include a virtual CPU or vCPU 714. The memory nodes 708 may be linked or pinned to virtual memory nodes or vNodes 716. When the memory node 708 is linked or pinned to a corresponding vNode 716, then data may be mapped directly from the memory nodes 708 to the corresponding vNode 716.

All the various components shown in host machine 702 may be connected with and to each other, or communicate to each other via a bus (not shown) or via other coupling or communication channels or mechanisms. The host machine 702 may further include a video display, audio device or other peripherals 718 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 720 (also referred to as disk drive unit), and a network interface device 722. The host machine 702 may further include a data encryption module (not shown) to encrypt data. The components provided in the host machine 702 are those typically found in computer systems that may be suitable for use with aspects of the present disclosure and are intended to represent a broad category of such computer components that are known in the art. Thus, the system 700 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 724 also may be a Solid-state Drive (SSD), a hard disk drive (HDD) or other includes a computer or machine-readable medium on which is stored one or more sets of instructions and data structures (e.g., data/instructions 726) embodying or utilizing any one or more of the methodologies or functions described herein. The data/instructions 726 also may reside, completely or at least partially, within the main memory node 708 and/or within the processor(s) 706 during execution thereof by the host machine 702. The data/instructions 726 may further be transmitted or received over a network 728 via the network interface device 722 utilizing any one of several well-known transfer protocols (e.g., Hyper Text Transfer Protocol (HTTP)).

The processor(s) 706 and memory nodes 708 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 702 and that causes the host machine 702 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital, or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 702, with each server 730 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

According to some non-limiting aspects, the present disclosure contemplates a method of customizing a user experience during a live event. The method can include receiving, via a host app server, geographic data associated with a location of a customer device, correlating, via the host app server, the geographic data associated with the location of the customer device to geographic data associated with a location of a live event, authorizing, via the host app server, the customer device to access a plurality of media associated with the live event and hosted by a media server based on the correlation, receiving, via the host app server, a media request from the customer device, wherein the media request includes media selected from the plurality of media, evaluating, via the host app server, the media request, adding, via the host app server, the media request to a queue of media based on the evaluation, wherein the queue of media is configured to be accessed from the media server and played by a performer device during the live event.

According to some non-limiting aspects, receipt of the media request and evaluation of the media request can occur during a first performance interval of the live event, and evaluation of the media request can include determining, via the host app server, that the queue of media should be accessed from the media server and played by the performer device during the first performance interval of the live event.

According to some non-limiting aspects, receipt of the media request and evaluation of the media request can occur during a first performance interval of the live event, and evaluation of the media request can include determining, via the host app server, that the queue of media should be accessed from the media server and played by the performer device during a second performance interval of the live event.

According to some non-limiting aspects, the method can further include receiving, via the host app server, a condition associated with fulfilment of the media request from the performer device, wherein evaluation of the media request can include determining, via the host app server, that the condition has been satisfied.

According to some non-limiting aspects, the method can further include receiving, via the host app server, a term associated with fulfilment of the media request from the performer device, and evaluation of the media request can include determining, via the host app server, that the term has been accepted.

According to some non-limiting aspects, evaluation of the media request can include evaluating, via the host app server, the media request relative to a plurality of other media requests received from a plurality of other customer devices.

According to some non-limiting aspects, evaluation of the media request can include evaluating, via the host app server, the media request relative to a plurality of other media requests received from a plurality of other customer devices.

According to some non-limiting aspects, the method can further include receiving, via a host app server, sensor data from the customer device, and wherein evaluation of the media request includes evaluating, via the host app server, the sensor data.

According to some non-limiting aspects, the geographic data can be autonomously and continuously transmitted to the host app server by the customer device.

According to some non-limiting aspects, generation of the media request can be based on an initially configured user preference stored by the host app server and provided via the customer device.

According to some non-limiting aspects, the method can further include generating, via the host app server, an insight based on the media request and the geographic data associated with the location of the customer device.

According to some non-limiting aspects, the present disclosure contemplates a system configured to customize a user experience during a live event, the system including a customer device including a first processor and a first memory configured to store a media request application that, when executed by the first processor, causes the customer device to retrieve geographic data associated with a location of the customer device, and generate a media request based on a user input, and a host app server including a second processor and a second memory configured to store a media request application that, when executed by the second processor, causes the host app server to receive the geographic data associated with the location of the customer device, correlate the geographic data associated with the location of the customer device to geographic data associated with a location of a live event, receive the media request from the customer device, wherein the media request includes media selected from a plurality of media hosted on a media server, evaluate the media request, and add the media request to a queue of media based on the evaluation, wherein the queue of media is configured to be accessed from the media server and played by a performer device during the live event.

According to some non-limiting aspects, receipt of the media request and evaluation of the media request can occur during a first performance interval of the live event, and evaluation of the media request can include determining that the queue of media should be accessed from the media server and played by the performer device during the first performance interval of the live event.

According to some non-limiting aspects, receipt of the media request and evaluation of the media request can occur during a first performance interval of the live event, and wherein evaluation of the media request can include determining that the queue of media should be accessed from the media server and played by the performer device during a second performance interval of the live event.

According to some non-limiting aspects, when executed by the first processor, the media request application further causes the customer device to autonomously and continuously transmit the geographic data is to the host app server.

According to some non-limiting aspects, when executed by the first processor, the media request application causes the customer device to generate an initially configured user preference based on a user input, and, when executed by the second processor, the media request application further causes the host server to receive the initially configured user preference from the user device, store the initially configured user preference, and wherein generation of the media request is based on the initially configured user preference stored by the host server.

According to some non-limiting aspects, when executed by the second processor, the media request application further causes the host app server to generate an insight based on the media request and the geographic data associated with the location of the customer device.

According to some non-limiting aspects, the present disclosure contemplates a host app server configured to customize a user experience during a live event, the host app server including a processor, and a memory configured to store a media request application that, when executed by the processor, causes the host app server to receive geographic data associated with a location of a customer device, correlate the geographic data associated with the location of the customer device to geographic data associated with a location of a live event, receive a media request from the customer device, wherein the media request includes media selected from a plurality of media hosted on a media server, evaluate the media request, and add the media request to a queue of media based on the evaluation, wherein the queue of media is configured to be accessed from the media server and played by a performer device during the live event.

According to some non-limiting aspects, receipt of the media request and evaluation of the media request can occur during a first performance interval of the live event, and wherein evaluation of the media request can include determining that the queue of media should be accessed from the media server and played by the performer device during the first performance interval of the live event.

According to some non-limiting aspects, receipt of the media request and evaluation of the media request can occur during a first performance interval of the live event, and wherein evaluation of the media request can include determining that the queue of media should be accessed from the media server and played by the performer device during a second performance interval of the live event.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. A method of customizing a user experience during a live event, the method comprising:
receiving, via a host app server, geographic data associated with a location of a customer device;
correlating, via the host app server, the geographic data associated with the location of the customer device to geographic data associated with a location of a live event;
authorizing, via the host app server, the customer device to access a plurality of media associated with the live event and hosted by a media server based on the correlation;
receiving, via the host app server, a media request from the customer device, wherein the media request comprises media selected from the plurality of media;
evaluating, via the host app server, the media request; and
adding, via the host app server, the media request to a queue of media based on the evaluation, wherein the queue of media is configured to be accessed from the media server and played by a performer device during the live event.

2. The method of claim 1, wherein receipt of the media request and evaluation of the media request occur during a first performance interval of the live event, and wherein evaluation of the media request comprises determining, via the host app server, that the queue of media should be accessed from the media server and played by the performer device during the first performance interval of the live event.

3. The method of claim 1, wherein receipt of the media request and evaluation of the media request occur during a first performance interval of the live event, and wherein evaluation of the media request comprises determining, via the host app server, that the queue of media should be accessed from the media server and played by the performer device during a second performance interval of the live event.

4. The method of claim 1, further comprising receiving, via the host app server, a condition associated with fulfilment of the media request from the performer device, and wherein evaluation of the media request comprises determining, via the host app server, that the condition has been satisfied.

5. The method of claim 1, further comprising receiving, via the host app server, a term associated with fulfilment of the media request from the performer device, and wherein evaluation of the media request comprises determining, via the host app server, that the term has been accepted.

6. The method of claim 1, wherein evaluation of the media request comprises evaluating, via the host app server, the media request relative to a plurality of other media requests received from a plurality of other customer devices.

7. The method of claim 1, wherein evaluation of the media request comprises evaluating, via the host app server, the media request relative to a plurality of other media requests received from a plurality of other customer devices.

8. The method of claim 1, further comprising receiving, via a host app server, sensor data from the customer device, and wherein evaluation of the media request comprises evaluating, via the host app server, the sensor data.

9. The method of claim 1, wherein the geographic data is autonomously and continuously transmitted to the host app server by the customer device.

10. The method of claim 9, wherein generation of the media request is based on an initially configured user preference stored by the host app server and provided via the customer device.

11. The method of claim 1, further comprising generating, via the host app server, an insight based on the media request and the geographic data associated with the location of the customer device.

12. A system configured to customize a user experience during a live event, the system comprising:
a customer device comprising a first processor and a first memory configured to store a media request application that, when executed by the first processor, causes the customer device to:
retrieve geographic data associated with a location of the customer device; and
generate a media request based on a user input; and
a host app server comprising a second processor and a second memory configured to store a media request application that, when executed by the second processor, causes the host app server to:
receive the geographic data associated with the location of the customer device;
correlate the geographic data associated with the location of the customer device to geographic data associated with a location of a live event;
receive the media request from the customer device, wherein the media request comprises media selected from a plurality of media hosted on a media server;
evaluate the media request; and
add the media request to a queue of media based on the evaluation, wherein the queue of media is configured to be accessed from the media server and played by a performer device during the live event.

13. The system of claim 12, wherein receipt of the media request and evaluation of the media request occur during a first performance interval of the live event, and wherein evaluation of the media request comprises determining that the queue of media should be accessed from the media server and played by the performer device during the first performance interval of the live event.

14. The system of claim 12, wherein receipt of the media request and evaluation of the media request occur during a first performance interval of the live event, and wherein evaluation of the media request comprises determining that the queue of media should be accessed from the media server and played by the performer device during a second performance interval of the live event.

15. The system of claim 12, wherein, when executed by the first processor, the media request application further causes the customer device to autonomously and continuously transmit the geographic data is to the host app server.

16. The system of claim 15, wherein, when executed by the first processor, the media request application causes the customer device to generate an initially configured user preference based on a user input, wherein, when executed by the second processor, the media request application further causes the host server to receive the initially configured user preference from the user device, store the initially configured user preference, and wherein generation of the media request is based on the initially configured user preference stored by the host server.

17. The system of claim 12, wherein, when executed by the second processor, the media request application further causes the host app server to generate an insight based on the media request and the geographic data associated with the location of the customer device.

18. A host app server configured to customize a user experience during a live event, the host app server comprising:
a processor; and
a memory configured to store a media request application that, when executed by the processor, causes the host app server to:
receive geographic data associated with a location of a customer device;
correlate the geographic data associated with the location of the customer device to geographic data associated with a location of a live event;
receive a media request from the customer device, wherein the media request comprises media selected from a plurality of media hosted on a media server;
evaluate the media request; and
add the media request to a queue of media based on the evaluation, wherein the queue of media is configured to be accessed from the media server and played by a performer device during the live event.

19. The host app server of claim 18, wherein receipt of the media request and evaluation of the media request occur during a first performance interval of the live event, and wherein evaluation of the media request comprises determining that the queue of media should be accessed from the media server and played by the performer device during the first performance interval of the live event.

20. The host app server of claim 18, wherein receipt of the media request and evaluation of the media request occur during a first performance interval of the live event, and wherein evaluation of the media request comprises determining that the queue of media should be accessed from the media server and played by the performer device during a second performance interval of the live event.
